(19) United States
(12) Patent Application Publication
(10) Pub. No.: US 2022/0089209 A1
(43) Pub. Date: Mar. 24, 2022

(54) BABY STROLLER COVER WITH MECHANICAL AIR FILTER

(71) Applicant: Ashley Amanda Steward, Clarksburg, MD (US)

(72) Inventor: Ashley Amanda Steward, Clarksburg, MD (US)

(21) Appl. No.: 17/027,537

(22) Filed: Sep. 21, 2020

(51) Int. Cl. B62B 9/14

(52) U.S. Cl. CPC B62B 9/142; B62B 2501/065

(57) ABSTRACT

A baby stroller cover is disclosed. The baby stroller cover includes a body and a motorized air filter unit affixed to the body. A viewing port is affixed to the body and positioned proximate to the motorize air filter unit. A baby stroller attachment component is coupled to the body. The viewing port is transparent. The motorized air filter unit provides filtered air within the body. The body substantially covers a baby stroller when attached thereto via the baby stroller attachment component. The body includes a water-resistant material. The body includes a polymeric material. The viewing port includes a clear polymeric material. The baby stroller attachment component includes a drawstring. The motorized air filter unit is a high efficiency particulate air filter unit. The body is attached to a frame of the baby stroller via the baby stroller attachment component.

### FIELD OF THE INVENTION

The present disclosure relates generally to baby stroller covers. More specifically, the present disclosure describes baby stroller cover with a mechanical air filter.

### BACKGROUND OF THE INVENTION

Baby strollers are used to transport small children (e.g., up to 4-5 years old) in the sitting position facing forward or backwards. Baby strollers typically include a fixed chair, a handle, and wheels each coupled to a frame. The frame can be collapsible. In the prior art, it is well known to provide covers for baby strollers to shield the child from sun, rain and insects. However, the prior art is void of solutions that address air quality.

### BRIEF DESCRIPTION OF THE DRAWINGS

Some of the embodiments will be described in detail, with reference to the following figures, wherein like designations denote like members, wherein:

FIG. 1 depicts an exemplary baby stroller known in the art.

FIG. 2 depicts a filtered baby stroller cover positioned on the exemplary baby stroller of FIG. 1, according to some embodiments.

FIG. 3, depicts the motorized air filter unit providing filtered air within the body 201, according to certain embodiments.

Unless otherwise specifically noted, articles depicted in the drawings are not necessarily drawn to scale.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate. As used herein, the term “dorsal” refers to positions that are located near, on, or towards the upper or top side of a structure.

The present disclosure includes many aspects and features. Moreover, while many aspects and features relate to, and are described in the context of a baby stroller cover with mechanical air filters, embodiments of the present disclosure are not limited to use only in this context. The instant disclosure seeks to provide a baby stroller cover that can filter external air of contaminants. The disclosed baby stroller cover can also protect against rain, snow, and other implement weather conditions.

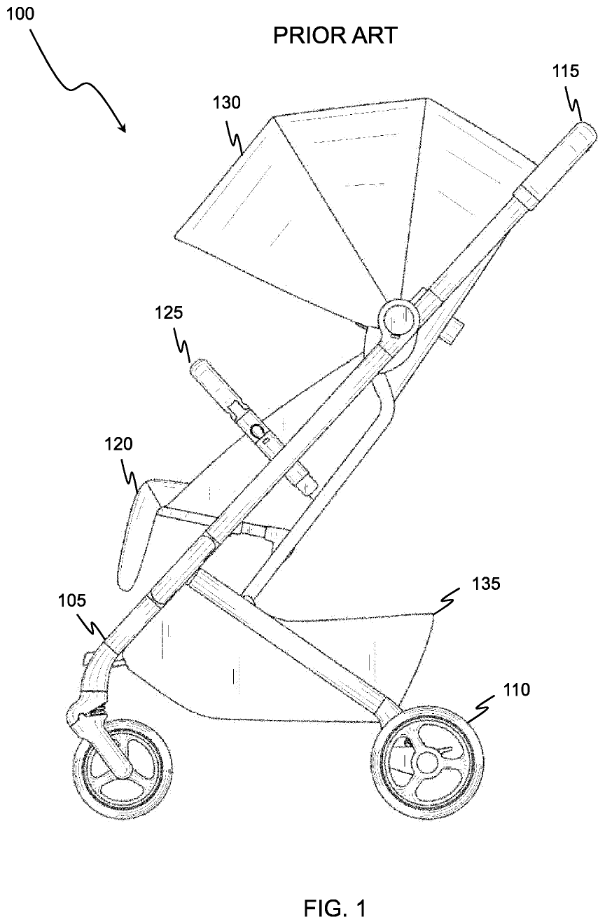

Baby strollers are hand-pushed vehicles that are used to transport infants and small children (e.g., up to about 4-5 years old) either laying down or in the sitting position facing forward or backwards. Baby strollers typically include a fixed chair, a handle, and wheels each coupled to a frame. The frame can be collapsible or fixed configuration. In the prior art, it is well known to provide covers for baby strollers to shield the child from sun, rain, snow, and insects. However, the prior art is void of solutions that address air quality. FIG. 1 depicts an exemplary baby stroller, generally 100, known in the art. The baby stroller 100 has a rectangular, rigid under frame 105 formed by two side members with wheeled axles joining the members. The rigid under frame 105 includes a seat 120 for the child, a restraining component 125 to restrict the child to the seat 120, a storage area 135 to store items (e.g., diaper bag, food, supplies, similar items, or two or more thereof) in, and a canopy 130 to shield the child from the elements all affixed thereto. The seat 120 can be one or more seats to hold one or more infants/children. The seat 120 can also be a basinet that holds one or more infants. Users (e.g., parents, legal guardians, or similar persons) can manipulate the baby stroller 100 using a handle 115 (e.g., to push the baby stroller 100). The wheeled axles includes wheels 110.

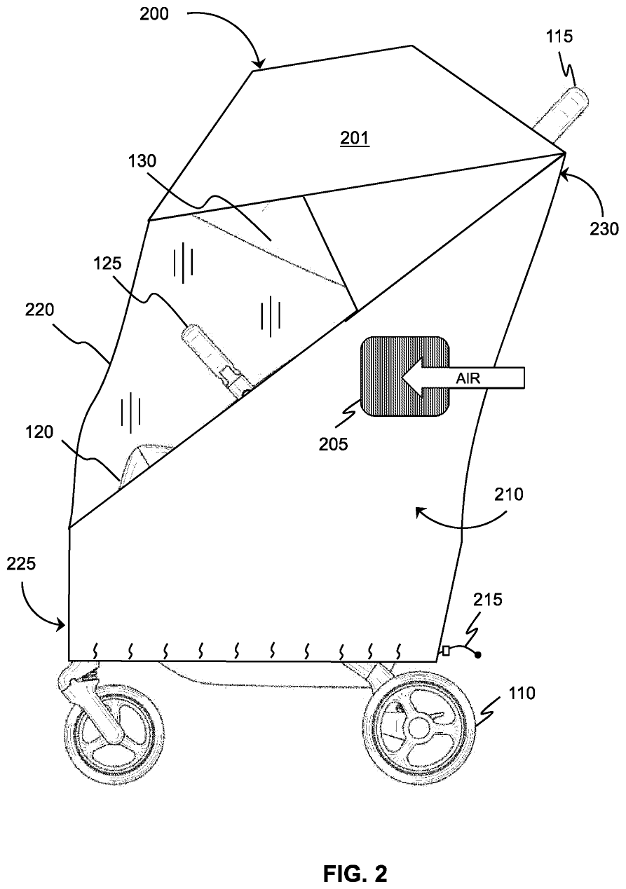

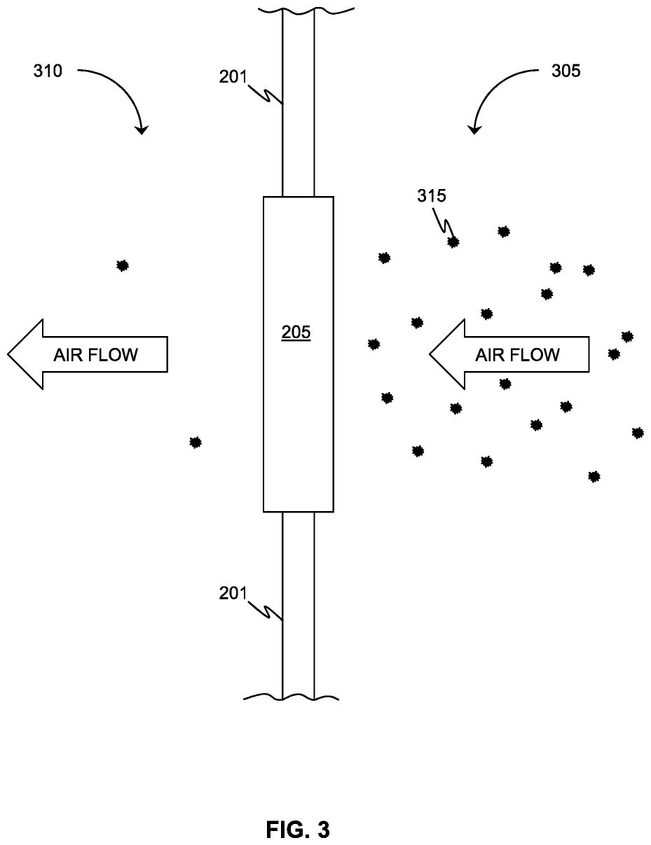

FIG. 2 depicts a filtered baby stroller cover, generally 200, positioned on the exemplary baby stroller of FIG. 1, generally 200, according to some embodiments. To be sure, the filtered baby stroller cover 200 can be utilized with any baby stroller that is configured to hold one or more children/infants. The filtered baby stroller cover 200 preferably includes a body 201 and at least one motorized air filter unit 205 affixed to the body 201. The body 201 includes a top portion 230 and a bottom portion 225. The body 201 can be made of a water-resistant material, such as a polymeric material (e.g., polyvinyl chloride, polyethylene, polypropylene, etc.). The motorized air filter unit 205 provides filtered air within the body 201 (i.e. area 310 of FIG. 3). FIG. 3 depicts the motorized air filter unit 205 providing filtered air within the body 201, according to certain embodiments. The area 305 refers to the area that is positioned external and proximate to the body 201. Similarly, the area 310 refers to the area that is positioned inside of the body 201. For example, the area 305 includes air contaminated with contaminants 315 (e.g., dust, pollen, mold, bacteria, other airborne particles, or a combination of two or more thereof).

In preferred embodiments, the motorized air filter unit 205 is a high efficiency particulate air (“HEPA”) filter unit. The motorized air filter unit 205 preferably filters air from area 305 and delivers it to the area 310. HEPA is a type of pleated mechanical air filter that is officially defined by the U.S. Dept. of Energy. Not to be limited by theory, this type of air filter can theoretically remove at least 99.97% of dust, pollen, mold, bacteria, and any airborne particles with a size of 0.3 microns or more. HEPA filters typically have an efficiency rating of 99.97% or better for all particle sizes. The motorized air filter unit 205 can have a minimum efficiency reporting value (“MERV”) rating of up to 16, which reflects that particles sized 0.3-1.0 microns are filtered with an efficiency of 75% or greater.

The filtered baby stroller cover 200 also includes a viewing port 220 that is affixed to the body 201 and positioned proximate to the motorized air filter unit 205. The viewing port 220 is preferably transparent to allow the child occupant the ability to observe their environment and the user to view the child/infant occupant. For example, the viewing port 220 can include a clear polymeric material (e.g., polyvinyl chloride, polyethylene, polypropylene, etc.). The body 201 can be folded to facilitate its storage. A baby stroller attachment component 215 is coupled to the body 200 (e.g., proximate to the bottom portion 225). The body 200 substantially covers a baby stroller (e.g., the baby stroller 100) when attached thereto via the baby stroller attachment 215 component. For example, the baby stroller attachment component 215 can be a drawstring that secures the filtered baby stroller cover 200 to the baby stroller 100 when drawn. The stroller attachment component 215 is preferably positioned proximate to the bottom portion 215. In preferred embodiments, the body 201 is attached to the frame 105 of the baby stroller (e.g., the baby stroller 100) via the baby stroller attachment component 215. Although the handle 115 is depicted as extending through the body 201 proximate to the upper portion 230, the body 201 can completely cover the handle 115 when affixed to the baby stroller 100, according to some embodiments.

Although the disclosure has been explained in relation to its preferred embodiment, it is to be understood that many other possible modifications and variations can be made without departing from the spirit and scope of the disclosure.

What is claimed is:

1. A baby stroller cover, comprising:
a body;
a motorized air filter unit affixed to the body;
a viewing port affixed to the body and positioned proximate to the motorize air filter unit; and
a baby stroller attachment component coupled to the body;
wherein the viewing port is transparent;
wherein the motorized air filter unit provides filtered air within the body; and
wherein the body substantially covers a baby stroller when attached thereto via the baby stroller attachment component.

2. The baby stroller cover of claim 1, wherein the body comprises a water-resistant material.

3. The baby stroller cover of claim 2, wherein the body comprises a polymeric material.

4. The baby stroller cover of claim 3, wherein the viewing port comprises a clear polymeric material.

5. The baby stroller cover of claim 4, wherein the baby stroller attachment component comprises a drawstring.

6. The baby stroller cover of claim 5, wherein the motorized air filter unit is a high efficiency particulate air filter unit.

7. The baby stroller cover of claim 6, wherein the body is attached to a frame of the baby stroller via the baby stroller attachment component.

8. A baby stroller cover, comprising:
a body;
a motorized air filter unit affixed to the body;
a viewing port affixed to the body and positioned proximate to the motorize air filter; and
a baby stroller attachment component coupled to the body;
wherein
the viewing port is transparent;
the motorized air filter unit provides filtered air within the body;
the body substantially covers a baby stroller when attached thereto via the baby stroller attachment component; and
the body comprises a water-resistant material.

9. The baby stroller cover of claim 8, wherein the body comprises a polymeric material.

10. The baby stroller cover of claim 9, wherein the viewing port comprises a clear polymeric material.

11. The baby stroller cover of claim 10, wherein the baby stroller attachment component comprises a drawstring.

12. The baby stroller cover of claim 11, wherein the motorized air filter unit is a high efficiency particulate air filter unit.

13. The baby stroller cover of claim 12, wherein the body is attached to a frame of the baby stroller via the baby stroller attachment component.

14. A baby stroller cover, comprising:
a body;
a motorized air filter unit affixed to the body;
a viewing port affixed to the body and positioned proximate to the motorize air filter; and
a baby stroller attachment component coupled to the body;
wherein
the viewing port is transparent;
the motorized air filter unit provides filtered air within the body;
the body substantially covers a baby stroller when attached thereto via the baby stroller attachment component;
the body comprises a water-resistant material; and
the body comprises a polymeric material.

15. The baby stroller cover of claim 14, wherein the viewing port comprises a clear polymeric material.

16. The baby stroller cover of claim 15, wherein the baby stroller attachment component comprises a drawstring.

17. The baby stroller cover of claim 16, wherein the motorized air filter unit is a high efficiency particulate air filter unit.

18. The baby stroller cover of claim 17, wherein the body is attached to a frame of the baby stroller via the baby stroller attachment component.
